(19) United States
(12) Patent Application Publication
(10) Pub. No.: US 2013/0067957 A1
(43) Pub. Date: Mar. 21, 2013

(54) METHOD OF PRODUCING GLASS

(71) Applicants: Zuyi Zhang, Yokohama-shi (JP); Yoshinori Kotani, Yokohama-shi (JP); Kenji Takashima, Tokyo (JP)

(72) Inventors: Zuyi Zhang, Yokohama-shi (JP); Yoshinori Kotani, Yokohama-shi (JP); Kenji Takashima, Tokyo (JP)

(73) Assignee: CANON KABUSHIKI KAISHA, Tokyo (JP)

(21) Appl. No.: 13/699,963

(22) PCT Filed: May 20, 2011
(86) PCT No.: PCT/JP2011/062150

§ 371 Date: Nov. 26, 2012

(30) Foreign Application Priority Data
Jun. 1, 2010 (JP) 2010-126326

(51) Int. Cl. C03C 11/00

(52) U.S. Cl. CPC C03C 11/005
USPC 65/31; 65/30.1

(57) ABSTRACT

Provided a method of producing a glass having a silica skeleton with a phase-separated structure, particularly in the case of a phase-separated glass, by selectively removing a compositionally deviated layer on the surface of a phase-separated borosilicate glass. The method of producing a glass includes forming a glass body containing silicon oxide, boron oxide, and an alkali metal oxide; and bringing an alkaline aqueous solution having a viscosity of 5 mPa·s or more to 200 mPa·s or less into contact with a surface of the glass body.

### TECHNICAL FIELD

The present invention relates to a method of producing a glass, and more particularly, to a method of producing a glass using etching of a glass.

### BACKGROUND ART

Conventionally, in a borosilicate glass containing an alkali oxide and boron oxide, most of glass compositions are liable to be affected by moisture in the air, glass weathering occurs, and a corrosion layer is formed on the surface. Once such surface layer is formed, boron oxide and an alkaline component are removed in the course of washing, heat treatment, etc., and a silica-rich surface layer containing a large amount of silicon oxide is formed on the surface. In this case, a stress may be generated by the difference in composition in the vicinity of the surface. The presence of such a silica-rich layer is particularly considered as a problem in a phase-separated borosilicate glass (see NPL 1). In this case, it is known that, due to the presence of a dense silicon oxide film on the surface, in an etching process of dissolving a borosilicate glass phase in a glass to form a porous glass, an etchant is kept out by the silica-rich surface layer, which prevents borate glass phase in the glass from being etched out.

In order to solve this problem, several methods are used. For example, PTL 1 discloses a technology in which a flat glass is etched after a surface layer is removed by about 10 μm by a method such as mechanical polishing. On the other hand, a method of removing a compositionally deviated surface layer by a chemical process has also been reported. In general, an acid solution containing hydrogen fluoride or the like is used as an etchant to dissolve components of a surface layer, or used for washing or pre-treatment of a glass substrate. However, in the case where the smoothness of a glass surface is required, it is necessary to adjust the concentration of an acid according to an etching time and a glass composition. In this case, care should be taken for handling hydrogen fluoride, and hence, an alternative etching technology has been demanded.

On the other hand, an alkali hydroxide aqueous solution can also dissolve a glass, and is often used for cleaning a glass surface, etc. According to NPL 2, in the case of applying an alkaline aqueous solution to a phase-separated borosilicate glass, a silica glass phase in the glass is severely eroded as well by the alkali. Therefore, there is a problem in that, when the glass is porosified by etching, the strength of a skeleton based on silicon oxide may be weakened.

In view of the foregoing, there is a demand for an etching method of removing a silica-rich layer formed on the surface of a borosilicate glass, selectively.

There is a strong demand for an etching method of removing a surface layer of a borosilicate glass selectively with less influence on a glass inner part as described above.

The present invention has been achieved in view of such background art. An object of the present invention is to provide a method of producing a glass, including removing a compositionally deviated layer on the surface of a borosilicate glass selectively, and more particularly, to provide a method of producing a glass having a skeleton of silicon oxide and pores, including removing a compositionally deviated layer on the surface of a phase-separated borosilicate glass selectively.

### CITATION LIST

### Patent Literature

PTL 1: Japanese Patent Application Laid-Open No. 562-297223

### Non Patent Literature

NPL 1: Eguchi, “New glass and physical properties thereof” (edited by Izumitani), p. 51, published by Business System Institute Co., Ltd., 1987
NPL 2: Mori et al., “Glass Engineering Handbook” (edited by Moritani et al.), p. 655, Asakura Publishing Co., Ltd., issued in 1963

### SUMMARY OF INVENTION

### Technical Problem

In order to solve the above-mentioned problems, according to the present invention, a method of producing a glass includes: forming a glass body containing silicon oxide, boron oxide, and an alkali metal oxide; and bringing an alkaline aqueous solution having a viscosity of 5 mPa·s or more to 200 mPa·s or less into contact with a surface of the glass body.

Further, according to the present invention, a method of producing a glass includes: forming a phase-separated glass containing silicon oxide, boron oxide, and an alkali metal oxide; bringing an alkaline aqueous solution having a viscosity of 5 mPa·s or more to 200 mPa·s or less into contact with a surface of the phase-separated glass; and bringing the phase-separated glass brought into contact with the alkaline aqueous solution into contact with at least one of an acid solution and water to form a pore in the phase-separated glass.

Further features of the present invention will become apparent from the following description of exemplary embodiments with reference to the attached drawings.

### BRIEF DESCRIPTION OF DRAWINGS

FIG. 1 is a view illustrating an example of a method of producing a glass of the present invention.

FIG. 2 is a view illustrating an example of a method of producing a glass of the present invention.

FIG. 3 is a photograph showing a glass having pores formed therein obtained by a method of producing a glass of the present invention.

### DESCRIPTION OF EMBODIMENTS

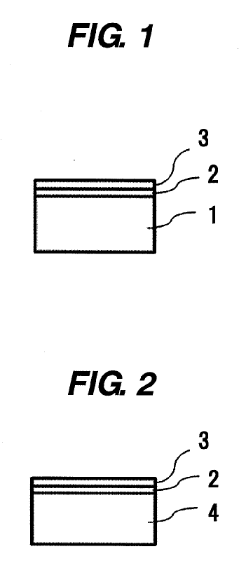

Hereinafter, the present invention is described in detail with reference to FIGS. 1 and 2.

FIG. 1 is a view illustrating one embodiment of a method of producing a glass according to the present invention, and a glass body is represented by 1, a surface compositionally deviated layer is represented by 2, and an alkaline aqueous solution is represented by 3.

Further, FIG. 2 is a view illustrating one embodiment of the method of producing a glass according to the present invention, and a phase-separated glass is represented by 4, a surface compositionally deviated layer is represented by 2, and an alkaline aqueous solution is represented by 3.

The method of producing a glass according to the present invention includes: forming a glass body containing silicon oxide, boron oxide, and an alkali metal oxide; and bringing an alkaline aqueous solution having a viscosity of 5 mPa·s or more to 200 mPa·s or less into contact with the surface of the glass body.

Further, a method of producing a borosilicate glass according to the present invention includes: forming a phase-separated glass containing silicon oxide, boron oxide, an alkali metal oxide; bringing an alkaline aqueous solution having a viscosity of 5 mPa·s or more to 200 mPa·s or less into contact with the surface of the phase-separated glass; and bringing the phase-separated glass brought into contact with the alkaline aqueous solution into contact with an acid solution and/or water to form pores in the phase-separated glass.

In the present invention, the borosilicate glass is formed by forming a glass body containing silicon oxide, boron oxide, and an alkali metal oxide, and in some cases, processing the surface of the glass body. In the case of a phase-separated glass, the method may include further heating the glass body for phase separation to form phase-separated glass. This heating is referred to as phase separation heating in this specification. With a particular composition, a phase-separated glass may be obtained even without performing the phase separation heating.

In general, the borosilicate glass is expressed by a weight ratio of oxides such as silicon oxide (silica SiO₂), boron oxide (B₂O₃), and an alkali metal oxide. The borosilicate glass contains silicon oxide, boron oxide, and an alkali metal oxide as main components, and may contain, for example, aluminum oxide, calcium oxide, and magnesium oxide as other metal oxides.

In a phase-separated glass, a borosilicate glass having a particular composition undergoes a phase separation phenomenon in which a glass is separated into a silicon oxide glass phase mainly containing silicon oxide and a borate glass phase mainly containing boron oxide and an alkali metal oxide in the course of the heat-treatment of the glass body. A glass that has undergone the phase separation phenomenon is referred to as phase-separated glass in this specification. Specific examples thereof include SiO₂—B₂O₂-M₂O (M: Li, Na, or K), SiO₂—B₂O₂—Al₂O₂-M₂O (M: Li, Na, or K), and SiO₂—B₂O₃—RO-M₂O (M: Li, Na, or K and R: Mg, Ca, or Ba) glasses.

A phase-separated borosilicate glass is, for example, an SiO₂ (55 to 80% by weight) —B₂O₂—Na₂O—(Al₂O₂)-based glass, an SiO₂ (35 to 55% by weight) —B₂O₂—Na₂O-based glass, an SiO₂—B₂O₂—CaO—Na₂O—Al₂O₂-based glass, an SiO₂—B₂O₃—Na₂O—RO (R: alkaline earth metal or Zn)-based glass, and an SiO₂—B₂O₂—CaO—MgO—Na₂O—Al₂O₂—TiO₂ (TiO₂ is contained up to 49.2 mol %)-based glass.

Regarding preferred compositions of preferred main components of the glass body used in the present invention, it is preferred that the composition of the alkali metal oxide be generally 2% by weight or more to 20% by weight or less, in particular, 3% by weight or more to 15% by weight or less.

It is preferred that the composition of boron oxide be generally 10% by weight or more to 55% by weight or less, and in particular, 15% by weight or more to 50% by weight or less.

It is preferred that the composition of silicon oxide be generally 45% by weight or more to 80% by weight or less, and in particular, 55% by weight or more to 75% by weight or less.

Further, it is preferred that the content of metal oxides other than silicon oxide, boron oxide, and an alkali metal oxide be generally 15% by weight or less, and in particular, 10% by weight or less.

The phase separation is performed generally where a glass is held at a temperature of about 500° C. to 700° C. for several hours to tens of hours. Depending upon the temperature and holding time, the state of phase separation changes, where the pore diameter and pore density vary.

It is ideal that the total amount of silicon oxide, boron oxide, and an alkali metal oxide contained in the entire glass be the same before and after the phase separation heat treatment. However, a part of boron oxide and an alkali metal oxide in the vicinity of the surface of the glass is lost due to the reaction with water vapor in the atmosphere or the sublimation during heat treatment, and apart from the phase separation formation in an inner part, a compositionally deviated layer mainly containing silicon oxide is formed on the surface.

Further, even in a general borosilicate glass, when the glass is subjected to surface polishing, a compositionally deviated layer mainly containing silicon oxide is formed on the surface in most cases.

The generation of a compositionally deviated layer on the surface can be confirmed by an observation procedure such as a scanning electron microscope (SEM), or an element analysis procedure such as X-ray photoelectron analysis (XPS), and the thickness of the compositionally deviated layer reaches several hundred nanometers in thickness in the case where the layer is thick.

Once a compositionally deviated layer is generated on the surface of a glass, solid silica covers a portion in which a phase separation has occurred, which adversely affects the elution of a soluble phase in the phase-separated glass with an acid solution preventing the porosification.

According to the present invention, etching is performed in which an alkaline aqueous solution having a viscosity of 5 mPa·s or more to 200 mPa·s or less is brought into contact with the surface of the borosilicate glass.

Etching a surface layer of a borosilicate glass using an alkaline aqueous solution (hereinafter, also referred to as etchant) having a viscosity of 5 mPa·s or more to 200 mPa·s or less basically refers to allowing an alkaline component to react with silicon oxide of the surface layer of the glass to corrode and remove the surface layer. In order to allow the reaction to proceed smoothly, an etchant film supplies an alkaline component required for removing silicon oxide of the surface layer. According to the present invention, in the case of etching a surface layer of a borosilicate glass, a method of coating the surface of a borosilicate glass with an etchant to form an etchant film, and bringing the etchant film into contact with the surface layer of the phase-separated glass, and a method of immersing a phase-separated glass directly in an etchant are used.

The alkaline aqueous solution used in the present invention has a viscosity of 5 mPa·s or more to 200 mPa·s or less. The viscosity of the alkaline aqueous solution may change depending upon the temperature as long as the viscosity under the condition of etching is 5 mPa·s or more to 200 mPa·s or less. The more preferred viscosity is 10 mPa·s or more to 200 mPa·s or less. When the viscosity is 5 mPa·s or more, the flowability in the vicinity of a glass is extremely reduced particularly in an interface region of the glass surface, and alkali ions and hydroxide ions are supplied to the vicinity of the compositionally deviated layer containing silicon oxide as a main component of the surface layer via the diffusion in the film. Therefore, the corrosion of silicon oxide proceeds gently. When the viscosity is 200 mPa·s or less, the inclusion of bubbles in the etchant is small, and the etchant can be brought into contact with the glass surface efficiently. Thus, the contact failure on the surface is reduced, and selective etching of the surface layer is performed entirely.

In the case of using the alkaline aqueous solution as a coating film, a coating film having a thickness of 5 μm or more can be preferably formed, and more preferably, a coating film having a thickness of about 10 μm is held stably. The film having a thickness of 5 μm or more can supply an alkaline component required for the compositionally deviated layer containing silicon oxide as a main component of the surface layer. Such coating film is held easily on the glass surface due to viscosity characteristics of 5 mPa·s or more and surface tension. Even when the compositionally deviated layer is immersed in an etchant, the reaction with silicon oxide proceeds gently, and the convection of a liquid is less compared with etching in an ordinary etchant. Thus, the non-uniform movement of reactive materials on the surface is suppressed.

The alkaline component contained in the alkaline aqueous solution is not particularly limited as long as it has an ability to dissolve silicon oxide and is soluble in water. A hydroxide having high basicity is, for example, lithium hydroxide, sodium hydroxide, potassium hydroxide, and tetramethylammonium hydroxide. Considering the basicity and cost, sodium hydroxide and potassium hydroxide are particularly preferred.

In general, the content of the alkaline component in the alkaline aqueous solution has only to satisfy the condition of basicity for corroding silicon oxide of the surface layer. It is desired that the content of the alkaline component in the alkaline aqueous solution be 3% by weight or more, preferably 5% by weight or more to 50% by weight or less. When the content of the alkaline component is 50% by weight or less, the handling of an etchant is easy and the cost for treating a waste liquid is suppressed.

In the alkaline aqueous solution of the present invention, water is used as a solvent for dissolving an alkaline component. Water is also required for corroding or dissolving the compositionally deviated layer containing silicon oxide as a main component of the surface layer in a case of corroding the surface layer of a borosilicate glass. However, only with the alkaline aqueous solution, the viscosity is low, and when the alkali content increases, the reactivity with a base increases although the viscosity increases. In this case, it is difficult to satisfy both the supply of an alkaline component and the control of a reaction speed. Therefore, in the present invention, a viscosity adjusting component is added to the alkaline aqueous solution. The viscosity adjusting component preferably does not react with an alkaline component and is not dissolved or degraded by the alkaline component. As the viscosity adjusting component, those which are dissolved in water and have the effect of increasing viscosity can be used. The viscosity adjusting component is not necessarily limited to one having a high viscosity, and the component has only to increase viscosity when mixed with an alkaline aqueous solution. The viscosity of a mixed-type solution may change largely depending upon the concentration of an additive and the content of water. Preferred examples of the viscosity adjusting component include high-viscosity solvents such as ethylene glycol, glycerin, and diethylene glycol. As a water-soluble polymer that is not dissolved by an alkali, polyvinyl alcohol and polyethylene glycol can also be used as the viscosity adjusting component. For example, in the case of polyethylene glycol (PEG), a polymer having an average molecular weight of 200 to 200,000 is preferred. Further, when the molecular weight of a polymer and the concentration of water are adjusted appropriately, if required, an etchant having a viscosity in a range of 5 mPa·s or more to 200 mPa·s or less can be obtained.

The alkaline aqueous solution in the present invention is effective with respect to a compositionally deviated layer containing silicon oxide as a main component of the glass surface. In particular, when volatile components such as boron oxide and sodium oxide are contained in a glass, in particular, a borosilicate glass, such modified compositionally deviated layer is certainly present to some degree, and hence, the alkaline aqueous solution of the present invention can exhibit effects particularly as an etchant.

In particular, in a phase-separated borosilicate glass, volatile components are reduced during heating treatment for phase separation for a long period of time, and hence, a compositionally deviated layer containing silicon oxide as a main component is formed easily on the surface.

In this case, an etchant of an alkaline aqueous solution is applied to a phase-separated borosilicate glass, and thus, the compositionally deviated layer containing silicon oxide as a main component of the surface layer is corroded first. As a coating amount, an etchant of an alkaline aqueous solution is applied in an amount larger than that of an alkali amount required for corroding the compositionally deviated layer containing silicon oxide as a main component of the surface layer, and thus, the surface layer is etched off selectively. Strictly, the thickness of the coating layer should be arranged depending upon the thickness and denseness of the compositionally deviated layer, and in general, the etchant is preferably applied so that the coating film has a thickness of 5 μm or more. The reaction time is adjusted depending upon the compositionally deviated layer of the surface layer. In the case where the compositionally deviated layer is thick, it is also possible to perform etching twice or more. Even when the corrosion of the surface layer is completed, the boron oxide component in the borosilicate glass phase in the phase-separated glass works as an acidic substance with respect to the etchant of the alkaline aqueous solution. Therefore, the alkaline component of the etchant hardly reaches the silicon oxide glass phase in the phase-separated glass immediately as compared with the case of a normal aqueous solution. Further, as compared with a low-viscosity alkaline solution, in the case of a high-viscosity etchant, water in an etching coating layer is consumed by the corrosion of silicon oxide and the dissolution of boron oxide, and hence a higher viscosity state is obtained in the vicinity of the interface. This tends to decrease the reaction speed gradually. In view of the foregoing, if the thickness of the surface compositionally deviated layer is recognized, the selective etching of the surface compositionally deviated layer can be controlled easily. Further, if required, the etching temperature of the surface layer can be set in a range of −5° C. to 90° C. for adjusting the reaction speed and the viscosity of an etchant, and the holding function on the surface.

When the surface of compositionally deviated layer is removed with an etchant in the present invention, a fresh glass surface becomes available. Such glass can be used appropriately as a substrate, surface coating, sputtering, or another structure material.

In the case of a phase-separated glass, a phase-separated glass that has been brought into contact with the alkaline aqueous solution is immersed in an acid solution or a solution of water, etc. to form pores in the phase-separated glass. When the surface compositionally deviated layer is removed with an etchant in the phase-separated borosilicate glass, a borate glass phase in the phase-separated glass is selectively eluted by an ordinary etching method using an acid solution of a phase-separated glass or a solution of water, etc.

In the case of using an etchant of an acid, the phase-separated glass is immersed in hydrochloric acid, sulfuric acid, phosphoric acid, or nitric acid each having an acid concentration of 0.1 mol/L to 5 mol/L (0.1 N to 5 N), and thus, a borosilicate glass phase is dissolved. Silica gel may be deposited in silica pores depending upon a glass composition. If required, a method involving etching in multiple stages using acid etchants having different acid concentrations or water can be used. As the etching temperature, the etching can be performed at room temperature to 95° C. Further, depending upon the composition of a phase-separated glass, pores may be formed by etching with only water without using an acid etchant.

In the case of a borosilicate glass on which a silica-rich layer is formed in the course of production or processing, the etchant of the present invention can be used.

Thus, it is not necessary to perform polishing for removing the surface layer of the phase-separated borosilicate glass unlike a conventional way by etching the surface layer of the phase-separated borosilicate glass with an etchant, followed by etching with a solution of an acid, water, or the like. Hence, the phase-separated borosilicate glass having an arbitrary surface shape with a curvature can be handled.

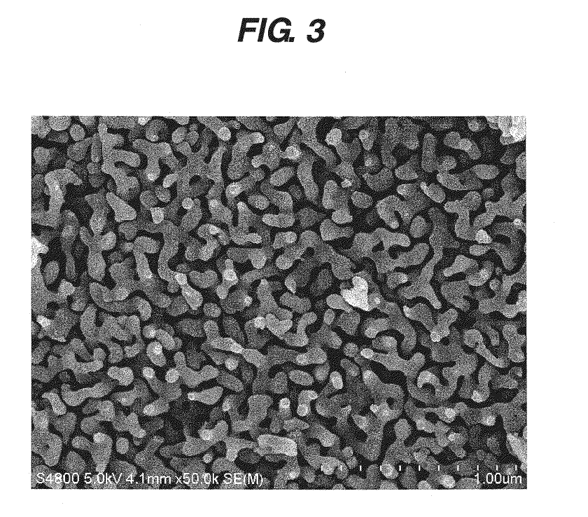

The phase separations are classified into a spinodal type and a binodal type. The pores obtained by a spinodal-type phase separation are penetrating pores linked from the surface to the inside as shown in FIG. 3, for example. The penetrating pores linked from the surface to the inside are formed by the spinodal structure based on silicon oxide. A binodal-type phase separation provides a structure having closed pores. It has been well known that pore diameters and their distribution can be controlled depending on conditions for the heat treatment during the production of the glass. Of the phase separation phenomena, the spinodal-type phase separation that provides a porous structure having penetrating pores linked from the surface to the inside, i.e., the so-called spinodal structure is preferred.

The average pore diameter of the glass, which is not particularly limited, desirably falls within the range of 1 nm to 1 μm, particularly 2 nm to 0.5 μm, further particularly 10 nm to 0.1 μm. The glass desirably has a porosity of generally 10 to 90%, particularly 20 to 80%.

The shape of the glass having pores formed therein is not particularly limited, and the glass is, for example, a membrane-like molded body of a tubular or plate-like shape. Those shapes can be appropriately selected depending on, for example, the applications of the glass.

The glass having pores formed therein is expected to find use in applications such as adsorbents, microcarriers, separation membranes, and optical materials because its porous structure can be uniformly controlled and its pore diameters can each be changed within a certain range.

Next, examples of the present invention are described.

### Example 1

Mixed powder of quartz powder, boron oxide, and sodium carbonate as a composition to be charged was placed in a platinum crucible and melted at 1,500° C. for 24 hours so as to obtain 65% by weight of SiO₂, 27% by weight of B₂O₂, and 8% by weight of Na₂O. Then, the temperature was lowered to 1,300° C., and a glass was poured to a graphite mold. The glass was allowed to stand to cool in the air for about 20 minutes, and held in a slow-cooling furnace at 500° C. for 5 hours. Finally, the glass was cooled over 24 hours. A block of the obtained borosilicate glass was cut to a size of 30 mm×30 mm×1.1 mm, and both surfaces thereof were polished to mirror finish. The resultant glass was allowed to stand in an atmosphere of air for 2 weeks and then subjected to phase separation in a muffle furnace at 600° C. over 24 hours. The obtained phase-separated glass plate was used for an etching experiment.

As a preparation of an etchant, an aqueous solution of 30% by weight of KOH was used as a material for KOH. Ethylene glycol and ion exchange water were used, and an etchant 1 was prepared so as to obtain 6% by weight of KOH, 80% by weight of ethylene glycol, and 14% by weight of H₂O. The viscosity of the etchant was measured with a vibratory viscometer (VISCOMATE, MODEL VM100A, CBC Co.), and as a result, the viscosity was 22 mPa·s at 26° C.

After the weight of one phase-separated glass had been previously measured, the phase-separated glass was immersed in the etchant 1 for 1 minute. Then, the phase-separated glass was pulled up to the air and allowed to stand for 5 minutes. The weight thereof was then measured. As a result, the weight increased by 0.17 g. When the specific gravity of the etchant 1 was defined to be 1 g/cm³, the thickness of a liquid film of the etchant covering the glass surface was about 90 μm. The sample was placed on a Teflon (registered trade mark) plate in a horizontal direction, and allowed to react with the surface layer of a phase-separated borosilicate glass in an environment of about 26° C. over 2.5 hours. After the glass sample surface had been washed with ion exchange water, the sample was cut to about 10×10 mm and then used for acid etching treatment.

The acid etching was performed by fixing the sample with a platinum wire and immersing the sample in 50 ml of 1 mol/L (1 N) nitric acid at 80° C. for 24 hours. After that, the sample was immersed in 50 ml of ion exchange water and rinsed for 3 hours. After the sample had been dried in the air for 12 hours, Fe-SEM observation was conducted. The pore diameter was about 50 nm, and the porosity was about 40% based on visual observation. When the surface layer was etched with the etchant 1, the etchant 1 did not reach a silica skeleton, and only the surface layer was etched. It was confirmed that the silica skeleton in the inner part was kept.

### Example 2

As a preparation of an etchant, an aqueous solution of 30% by weight of KOH was used as a material for KOH. Ethylene glycol and ion exchange water were used, and an etchant 2 was prepared so as to obtain 10% by weight of KOH, 66% by weight of ethylene glycol, and 24% by weight of H₂O. The viscosity of the etchant was measured with a vibratory viscometer (VISCOMATE, MODEL VM100A, CBC Co.), and as a result, the viscosity was 23 mPa·s at 27° C.

After the weight of the same phase-separated glass as in Example 1 had been measured, the phase-separated glass was immersed in the etchant 2 for 1 minute. Then, the phase-separated glass was pulled up to the air and allowed to stand for 5 minutes. The weight thereof was then measured. As a result, the weight increased by 0.15 g. When the specific gravity of the etchant 2 is defined to be 1.1 g/cm³, the thickness of a liquid film of the etchant covering the glass surface was estimated to be about 80 μm. The sample was placed on a Teflon (registered trade mark) plate in a horizontal direction, and allowed to react with the surface layer of a phase-separated borosilicate glass at about 27° C. over 2 hours. After the glass sample surface had been washed with ion exchange water, the sample was cut to about 10×10 mm and then used for acid etching treatment.

The acid etching was performed by fixing the sample with a platinum wire and immersing the sample in 50 ml of 1 mol/L (1 N) nitric acid at 80° C. for 24 hours. After that, the sample was immersed in 50 ml of ion exchange water and rinsed for 3 hours. After the sample had been dried in the air for 12 hours, Fe-SEM observation was conducted. The pore diameter was about 50 nm, and the porosity was about 40% based on visual observation in the same way as in Example 1. It was confirmed that the silica skeleton in the inner part was kept.

### Example 3

Mixed powder of quartz powder, boron oxide, and sodium carbonate as a composition to be charged was placed in a platinum crucible and melted at 1,500° C. for 24 hours so as to obtain 65% by weight of SiO₂, 24% by weight of B₂O₂, and 11% by weight of Na₂O. Then, the temperature was lowered to 1,300° C., and a glass was poured to a graphite mold. The glass was allowed to stand to cool in the air for about 20 minutes, and held in a slow-cooling furnace at 500° C. for 5 hours. Finally, the glass was cooled over 24 hours. A block of the obtained borosilicate glass was cut to a size of 30 mm×30 mm×1.1 mm, and both surfaces thereof were polished to mirror finish. The glass was allowed to stand in the air for 2 weeks and treated at 500° C. for 24 hours. The glass was irradiated with laser light and observed, and split-phase was not observed. A part of the glass was broken, and the cross-section and the polished surface were evaluated by XPS. On the polished surface, it was confirmed that silica was present in a large amount.

As a preparation of an etchant, an aqueous solution of 30% by weight of KOH was used as a material for KOH. Ethylene glycol and ion exchange water were used, and an etchant 3 was prepared so as to obtain 20% by weight of KOH, 33% by weight of ethylene glycol, and 46% by weight of H₂O. The viscosity of the etchant was measured with a vibratory viscometer (VISCOMATE, MODEL VM100A, CBC Co.), and as a result, the viscosity was 18.6 mPa·s at 27° C.

After the weight of one borosilicate glass subjected to heat treatment had been measured, the borosilicate glass was immersed in the etchant 3 for 1 minute. Then, the borosilicate glass was pulled up to the air and allowed to stand for 5 minutes. The weight thereof was then measured. As a result, the weight increased by 0.13 g. When the specific gravity of the etchant 3 was defined to be 1.1 g/cm³, the thickness of a liquid film of the etchant covering the glass surface was estimated to be about 60 μm.

The sample was placed on a Teflon (registered trade mark) plate in a horizontal direction, and allowed to react with the surface layer of a phase-separated borosilicate glass at about 27° C. over 5 hours. The glass sample surface was washed with ion exchange water. After that, the sample was dried, and then the etching surface was evaluated by XPS. As a result, the relative strength (1 s, 193 eV of boron and 1 s, 172 eV of sodium) of the peak derived from 2p track of Si in 104 eV of binding energy was almost the same level as the spectrum of the cross-section. It was confirmed that the silica-rich layer on the surface was scraped with the etchant.

### Example 4

Mixed powder of quartz powder, boron oxide, sodium carbonate, and alumina as a composition to be charged was placed in a platinum crucible and melted at 1,500° C. for 24 hours so as to obtain 62% by weight of SiO₂, 27.5% by weight of B₂O₃, 9% by weight of Na₂O, and 1.5% by weight of Al₂O₃. Then, the temperature was lowered to 1,300° C., and a glass was poured to a graphite mold. The glass was allowed to stand to cool in the air for about 20 minutes, and held in a slow-cooling furnace at 500° C. for 5 hours. Finally, the glass was cooled over 24 hours. A block of the obtained borosilicate glass was cut to a size of 30 mm×30 mm×1.1 mm, and both surfaces thereof were polished to mirror finish. The resultant glass was allowed to stand in the air for 2 weeks and treated at 560° C. for 24 hours. The sample was slightly whitish, and it was confirmed that phase separation occurred in the period (phase-separated borosilicate glass 2).

As a preparation of an etchant, an aqueous solution of 30% by weight of KOH was used as a material for KOH. Diethylene glycol and ion exchange water were used, and an etchant 4 was prepared so as to obtain 15% by weight of KOH, 35.5% by weight of diethylene glycol, and 49.5% by weight of H₂O. The viscosity of the etchant was measured with a vibratory viscometer (VISCOMATE, MODEL VM100A, CBC Co.), and as a result, the viscosity was 9 mPa·s at 26° C.

After the weight of one phase-separated glass had been previously measured, the phase-separated glass was immersed in the etchant 4 for 1 minute. Then, the phase-separated glass was pulled up to the air and allowed to stand for 5 minutes. The weight thereof was then measured. As a result, the weight increased by 0.07 g. When the specific gravity of the etchant 1 was defined to be 1.1 g/cm³, the thickness of a liquid film of the etchant covering the glass surface was about 40 μm.

The sample was placed on a Teflon (registered trade mark) plate in a horizontal direction, and allowed to react with the surface layer of a phase-separated borosilicate glass at about 26° C. over 3 hours. After the glass sample surface had been washed with ion exchange water, the sample was cut to about 10×10 mm, and then used for acid etching treatment.

The acid etching was performed by fixing the sample with a platinum wire and immersing the sample in 50 ml of 1 mol/L (1 N) nitric acid at 80° C. for 24 hours. After that, the sample was rinsed in 50 ml of ion exchange water for 3 hours. After the sample had been dried in the air for 12 hours, Fe-SEM observation was conducted. The pore diameter was about 30 nm, and the porosity was about 45% based on visual observation. When the surface layer was etched with the etchant 4, the etchant 4 did not reach a silica skeleton, and only the surface layer was etched. It was confirmed that the silica skeleton in the inner part was kept.

### Example 5

As a preparation of an etchant, an aqueous solution of 30% by weight of KOH was used as a material for KOH. Diethylene glycol and ion exchange water were used, and an etchant 5 was prepared so as to obtain 15% by weight of KOH, 50% by weight of diethylene glycol, and 35% by weight of H₂O. The viscosity of the etchant was measured with a vibratory viscometer (VISCOMATE, MODEL VM100A, CBC Co.), and as a result, the viscosity was 42 mPa·s at 26° C.

After the weight of one phase-separated borosilicate glass of Example 4 had been measured, the phase-separated borosilicate glass was immersed in the etchant 1 for 1 minute. Then, the phase-separated borosilicate glass was pulled up to the air and allowed to stand for 5 minutes. The weight thereof was then measured. As a result, the weight increased by 0.07 g. When the specific gravity of the etchant 1 was defined to be 1.1 g/cm³, the thickness of a liquid film of the etchant covering the glass surface was about 40 μm. The sample was placed on a Teflon (registered trade mark) plate in a horizontal direction, and allowed to react with the surface layer of a phase-separated borosilicate glass at about 26° C. over 8 hours. After the glass sample surface had been washed with ion exchange water, the sample was cut to about 10×10 mm and then used for acid etching treatment.

The acid etching was performed by fixing the sample with a platinum wire and immersing the sample in 50 ml of 1 mol/L (1 N) nitric acid at 80° C. for 24 hours. After that, the sample was rinsed in 50 ml of ion exchange water for 3 hours. After the sample had been dried in the air for 12 hours, Fe-SEM observation was conducted. The pore diameter was about 30 nm, and the porosity was about 45% based on visual observation. When the surface layer was etched with the etchant 3, the etchant 3 did not reach a silica skeleton, and only the surface layer was etched. It was confirmed that the silica skeleton in the inner part was kept.

### Comparative Example 1

As a comparative etchant, an aqueous solution of 10% by weight of KOH was used. The viscosity was about 3 mPa·s at 26° C. The phase-separated borosilicate glass of Example 4 was immersed in the comparative etchant for 1 minute. Then, the phase-separated borosilicate glass was pulled up to the air and allowed to stand for 5 minutes. As a result, the etchant dripped off and a stable liquid film was hardly formed on the glass surface.

The phase-separated borosilicate glass was immersed in the comparative etchant for 5 hours and allowed to react. After the glass sample surface had been washed with ion exchange water, the sample was cut to about 10×10 mm and then used for acid etching treatment. The acid etching was performed by fixing the sample with a platinum wire and immersing the sample in 50 ml of 1 mol/L (1 N) nitric acid at 80° C. for 24 hours. After that, the sample was rinsed in 50 ml of ion exchange water for 3 hours. After the sample had been dried in the air for 12 hours, Fe-SEM observation was conducted. Although it was confirmed that the surface layer of the glass was scraped, the skeleton of silica having a phase separation structure became thin and was collapsed in a number of parts.

### INDUSTRIAL APPLICABILITY

According to the method of producing a glass according to the present invention, a compositionally deviated layer on the surface of a borosilicate glass can be removed selectively, and in the production of a porous glass, a compositionally deviated layer on the surface of a phase-separated borosilicate glass can be removed selectively, and thus, porous phase-separated silica can be produced without breaking a silica skeleton of a phase-separated structure while keeping a strong silica skeleton. The present invention can be utilized for washing and etching of a substrate of an ordinary borosilicate glass, and in a phase-separated glass, the glass can be porosified while keeping the smoothness of the surface. Thus, the present invention can be utilized in a field in which a phase-separated glass is used for a separation membrane or an optical material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-126326, filed Jun. 1, 2010, which is hereby incorporated by reference herein in its entirety.

1. A method of producing a glass, comprising:
forming a glass body containing silicon oxide, boron oxide, and an alkali metal oxide; and
bringing an alkaline aqueous solution having a viscosity of 5 mPa·s or more to 200 mPa·s or less into contact with a surface of the glass body.

2. A method of producing a glass, comprising:
forming a phase-separated glass containing silicon oxide, boron oxide, and an alkali metal oxide;
bringing an alkaline aqueous solution having a viscosity of 5 mPa·s or more to 200 mPa·s or less into contact with a surface of the phase-separated glass; and
bringing the phase-separated glass brought into contact with the alkaline aqueous solution into contact with at least one of an acid solution and water to form a pore in the phase-separated glass.

3. The method of producing a glass according to claim 1, wherein a content of an alkaline component contained in the alkaline aqueous solution is 3% by weight or more.

4. The method of producing a glass according to claim 1, wherein the alkaline aqueous solution contains a viscosity adjusting component.

5. The method of producing a glass according to claim 4, wherein the viscosity adjusting component comprises at least one selected from the group consisting of ethylene glycol, glycerin, diethylene glycol, polyvinyl alcohol, and polyethylene glycol.

6. The method of producing a glass according to claim 2, wherein a content of an alkaline component contained in the alkaline aqueous solution is 3% by weight or more.

7. The method of producing a glass according to claim 2, wherein the alkaline aqueous solution contains a viscosity adjusting component.

8. The method of producing a glass according to claim 7, wherein the viscosity adjusting component comprises at least one selected from the group consisting of ethylene glycol, glycerin, diethylene glycol, polyvinyl alcohol, and polyethylene glycol.

9. A method of producing a glass, comprising:
preparing a phase-separated glass containing silicon oxide, boron oxide, and an alkali metal oxide;
bringing an alkaline aqueous solution having a viscosity of 5 mPa·s or more to 200 mPa·s or less into contact with a surface of the phase-separated glass; and
bringing the phase-separated glass brought into contact with the alkaline aqueous solution into contact with at least one of an acid solution and water to form a pore in the phase-separated glass.

10. The method of producing a glass according to claim 9, wherein a content of an alkaline component contained in the alkaline aqueous solution is 3% by weight or more.

11. The method of producing a glass according to claim 9, wherein the alkaline aqueous solution contains a viscosity adjusting component.

12. The method of producing a glass according to claim 11, wherein the viscosity adjusting component comprises at least one selected from the group consisting of ethylene glycol, glycerin, diethylene glycol, polyvinyl alcohol, and polyethylene glycol.
